(19) United States
(12) Patent Application Publication
(10) Pub. No.: US 2007/0090768 A1
(43) Pub. Date: Apr. 26, 2007

(54) Lighting device for a discharge lamp

(75) Inventors: Toshiaki Shiba, Ehime-ken (JP); Eiiji Abe, Ehime-ken (JP)

Correspondence Address: BANNER & WITCOFF, LTD., 1100 13th STREET, N.W., SUITE 1200, WASHINGTON, DC, 20005-4051, US

(73) Assignee: Harison Tobhiba Lighting Corporation, Ehime-ken (JP)

(21) Appl. No.: 10/560,313

(22) PCT Filed: Jun. 11, 2004
(86) PCT No.: PCT/JP04/08194

§ 371 Date: Dec. 9, 2005

(30) Foreign Application Priority Data
Jun. 13, 2003 (JP) 2003-169412

(51) Int. Cl. H05B 39/04

(52) U.S. Cl. 315/209 R

(57) ABSTRACT

The lighting device for a discharge lamp supplies HF pulse voltage from an HF power source circuit to an external electrode and lights an external electrode type fluorescent lamp 13 using rare gas. The fluorescent lamp 13 includes rare gas having a pressure of 120 torr or higher, and is supplied with a lamp current having a frequency in a range from 24 kHz to 34 kHz. The lighting device drives the fluorescent lamp 13 with high luminance and without flickering even under a light control is applied.

Further, with the lighting device for a discharge lamp according to the embodiment of the present invention, the drive frequency of the fluorescent lamp 13 is selected from a frequency band ranging from 24 kHz to 34 kHz, in which an audible noise is not generated, in a high ratio light control mode including 100%. The drive frequency of the discharge lamp fluorescent lamp 13 is selected from a lower frequency band ranging from 20 kHz to 24 kHz, in a low ratio light control mode. As a result, stable and high luminance lighting is realized in the high ratio light control mode, in which a positive column in the lamp does not shrink.

### TECHNICAL FIELD

The present invention relates to a lighting device used for a external electrode type fluorescent lamp.

### BACKGROUND TECHNOLOGY OF THE INVENTION

Conventionally, a cold cathode fluorescent lamp enclosed with mercury has been used for a back light for liquid crystal displays. Recently, however, a fluorescent lamp enclosed with xenon instead of mercury which is a hazardous substance is under development.

Generally, the principle of external electrode type dielectric barrier discharge using rare gas is described as follows. In an external electrode type dielectric barrier discharge lamp, a discharge plasma space is formed, in which excimer molecules are generated by a dielectric barrier discharge of the rare gas enclosed in a lamp tube. At least one electrode of a pair of electrodes to excite discharge phenomenon is located on the outer surface of the glass tube to act as an external electrode. Thus, the structure is such that a glass material, which is a dielectric material, is located between the external electrode and the rare gas for discharge. An electricity power supply device for supplying HF high voltage to the external electrodes is connected with the external electrode through a step-up transformer. Thus, the rare gas discharge lamp is lit by HF high voltage supplied from power supply device.

FIG. 1 shows a structure of the external electrode fluorescent lamp enclosed with xenon gas as one example of the external electrode type dielectric barrier discharge lamp, wherein (a) is a side view, (b) is a side cross section. As shown in FIG. 1, a discharge medium containing at least xenon is enclosed in a glass tube 1. A phosphor 2 is provided on the inner wall of the glass tube 1. At one end of the glass tube 1, an inner electrode 4 is provided, which is sealed in the glass tube 1 through a lead-in wire 3. On the outer wall of the glass tube 1, an electricity conducting material 1 of arbitrary shape is used as an external electrode 5, for example, an electricity conducting material (electricity conducting wire) with spirally wound shape is arranged along a tube axis is used. The surface of the glass tube 1 is coated with a translucent heat shrinkage tube 6 including the external electrode to prevent displacement of the external electrode 5. A voltage supply wire 8 is connected with the inner electrode 4 through the lead-in wire 3, a voltage supply wire 8′ is connected with the external electrode 5 through a fixing metal bar 7.

An HF voltage, which alternately changes between a positive voltage and a negative voltage, is supplied from power source (inverter) between electrodes 4, 5 through voltage supply line 8, 8′ for lighting the external electrode type fluorescent lamp. Thus, discharge is originated in the glass tube 1 and an ultraviolet ray is emitted from xenon. The ultraviolet ray incident on the phosphor 2 applied on the inner wall of the glass tube 1 is converted there to a visible light. The visible light is transmitted outside of the glass tube 1 and is thus utilized as a light source.

FIG. 2, FIG. 3 are block diagrams showing an outline configuration of a lighting device conventionally used for lighting an external electrode type fluorescent lamp described above. In the lighting device, an external electrode type fluorescent lamp 13 is connected with secondary coil of a transformer T1. One end of primary coil of the transformer T1 is connected with the connecting point of a pair of capacitors C1, C2, which are connected in series. The series-connected capacitors C1, C2 are connected between the power source Vcc and the ground potential point GND. That is, one end of the primary coil of the transformer T1 is connected with a central point of a potential of a bias voltage between the power source voltage Vcc and the ground. The other end of the primary coil of the transformer T1 is connected with the connecting point of a pair of circuit elements Z1, Z2, which are connected in series. Each of the circuit elements Z1, Z2 is composed of elements having resistance component such as coils, diodes, or resistors, or group of elements composed of them. The series-connected circuit elements Z1, Z2 are connected between the power source voltage Vcc and the ground GND through semiconductor switching elements S1, S2 respectively. The semiconductor switching elements S1, S2 are alternately driven ON/OFF by drive signals (1)11 and (2)12 outputted from control circuit 10, to supply the primary coil of the transformer T1 with a HF square wave voltage.

FIG. 2 shows an operation, in which the semiconductor switching element S1 is turned OFF by a drive signal (1)11 and the semiconductor switching element S2 is turned ON by a drive signal (2)12. An electric current I1 is generated in the primary coil of the transformer T1 as shown by a broken line with an arrow and thus a positive lamp current is generated as will be mentioned later. That is, the current I1 flows in the circuit; power source Vcc—capacitor C1—primary coil of the transformer T1—circuit element Z2—semiconductor switching element S2—ground GND.

FIG. 3 shows an operation, in which the semiconductor switching element S1 is turned ON by the drive signal (1)11, and semiconductor switching element S2 is turned OFF by the drive signal (2)12. An electric current I2 is generated in the primary coil of the transformer T1 as shown by a broken line with an arrow and thus a negative lamp current is generated as will be mentioned later. That is, the current I2 flows in the circuit; power source Vcc—semiconductor switching element S1—circuit element Z1—primary coil of the transformer T1—capacitor C2—ground GND.

FIG. 4 is a timing chart showing waveforms of drive signal (1)11, drive signal (2)12, voltage generated in the primary coil of the transformer T1, and the lamp current flowing in the external electrode type fluorescent lamp 13 connected with the secondary coil of the transformer T1 in the lighting device for a discharge lamp shown in FIG. 2, FIG. 3. As shown in the figure, the drive signals (1)11 and the drive signal (2)12 have a repetition cycle a phase of which is different from each other by 180°. Thus, the voltage generated in the primary coil of lamp driving transformer T1 repeats the change between low level (L) and high level (H) at each ON periods of the drive signals (1)11 and (2)12, in a manner as L→H→L→H→L→H. Thus, the positive and negative lamp current is supplied to the xenon external electrode type fluorescent lamp 13 connected with the secondary coil of the transformer T1. Here, the timing chart shown in FIG. 4 is a waveform chart when frequency of drive signal (1)11 and (2)12 is 20 kHz respectively and a light control ratio is 2%.

FIG. 5 is a waveform chart of the lamp voltage and the lamp current observed by a cathode-ray oscilloscope when frequency is 20 kHz and the light control ratio is 100%. FIG. 6 is a waveform chart showing an enlarged view of a portion B1 in FIG. 5.

In the conventional lighting device for the discharge lamp as described above, the HF pulse voltage supplied from the secondary coil of transformer T1 generally has a repetition frequency selected in the range from 18 kHz to 20 kHz and drives the discharge lamp to light. In practice however, the lighting device for the discharge lamp is driven by the HF pulse voltage having a repetition frequency of around 20 kHz, because the transformer generates vibration noise of frequency lower than 20 kHz, which is in an audible range.

However, such conventional lighting device for the discharge lamp has a drawback that a sufficient luminance of the discharge lamp cannot be obtained. An electric field in the glass tube becomes too strong to shrink a positive column, if a peak value of the lamp current is raised in order to increase the luminance by raising input power to the lamp. As a result, such problems arise that the luminance of the discharge lamp is decreased, on the contrary, and a flickering takes place in the luminance of the lamp making a stable light emission impossible.

Further, if the peak value of the lamp current is raised, power consumption in electric parts such as diodes, FETs etc. increases exponentially with the increase of the flowing current. Thus, power efficiency decreases and a problem of heat generation occurred.

The present invention is made to solve such conventional technical problems. It is an object of the present invention to supply a lighting device for a discharge lamp capable of lighting the external electrode type dielectric barrier discharge lamps using rare gas with high luminance and less flickering.

It is another object of the present invention to supply a lighting device for a discharge lamp capable of lighting external electrode type dielectric barrier discharge lamps using rare gas even under a low ratio lighting control without flickering.

### DISCLOSURE OF THE INVENTION

FIG. 7 is a graph showing a result of measurement of a relation between the luminance of the external electrode type fluorescent lamp and the drive frequency of the lighting device. The lamp has a structure shown in FIG. 1 having a pressure of rare gas higher than 120 torr and is supplied with a constant input power. FIG. 8 is a graph showing a result of measurement of the relation between the luminance of the external electrode type fluorescent lamp and the drive frequency of the lighting device with a constant input voltage.

Here, the external electrode type fluorescent lamp used in the measurement is a lamp, which has a tube having a length of 160 mm and a diameter of 3 mm, enclosed with xenon, neon, and argon, and which has power consumption of 7.0 to 7.5 W. The lamp is used for the back light for 7 inch navigation display device.

FIG. 7 is a graph showing the luminance of the discharge lamp and the lamp current measured for the varying frequency of HF pulse signal supplied by the lighting device for the discharge lamp, while the output voltage and current of the lighting device is so adjusted as to make the input power supplied to the discharge lamp constant. The condition that the input power supplied to discharge lamp is kept constant is required for a back light device incorporated in electronics instruments, which makes much of energy saving. FIG. 8 is a graph showing the luminance of the discharge lamp and the lamp current measured for the varying frequency of HF pulse signal supplied by the lighting device for the discharge lamp, while the output voltage and current of the lighting device is so adjusted as to make the input voltage supplied to the discharge lamp constant. The condition that the input voltage supplied to discharge lamp is kept constant is required for a back light device incorporated in a navigation system for cars, which is driven by a constant voltage battery.

The lighting device for a discharge lamp according to the present invention is able to light the external electrode type discharge lamp having a pressure of the rare gas, which is equal to or higher than 120 torr, with high luminance and without any shrinkage of a positive column, which brings about the flickering, by selecting the frequency of the lamp current supplied to the lamp in the range 24 kHz to 34 kHz. The operating condition is obtained as a result of the examination of the two graphs from a comprehensive standpoint.

Further, the lighting device for a discharge lamp according to the present invention enables the stable lighting of the lamp without the flickering even under the low light control ratio by shifting the frequency range to the range from 20 kHz to 24 kHz, when the driving frequency of the discharge lamp is set in the range 24 kHz to 34 kHz and the light control ratio is too low to bring about the flickering.

More specifically, in the lighting device for a discharge lamp according to the present invention, the light control ratio used for luminance control of the discharge lamp is automatically judged and the drive frequency of the lamp is made low in the range of low light control ratio, in which the flicker of lamp can easily be seen, while the drive frequency of the lamp is made high in the high light control ratio range, in which the flickering is hardly seen. As a result, stable, flicker free and high luminance lighting can be realized in the entire range of light control ratio.

The lighting device for a discharge lamp according to the present invention includes a light control signal generating circuit, a circuit generating a first frequency drive signal in the range from 24 kHz to 34 kHz and a second frequency drive signal in the range from 20 kHz to 24 kHz each of which is pulse width modulated by an output of the light control signal generating circuit, a lighting control ratio judging circuit, to which the output of the light control signal generating circuit is supplied, a drive signal selecting switch, which selectively switches the drive signal of the first frequency and the drive signal of the second frequency according to the output of the light control ratio judging circuit, a switching element which is driven by the drive signal of the first or the second frequency selected by the drive signal selecting switch, and a transformer a primary coil of which is connected with the switching element and a secondary coil is connected with the external electrode type dielectric barrier discharge lamp, wherein the drive signal selecting switch selects the first frequency drive signal when the light control ratio judged by the light control ratio judging circuit is higher than or equal to a prescribed value and selects the second frequency drive signal when the light control ratio is lower than or equal to a prescribed value to supply the selected drive signal to the switching element.

### BRIEF DESCRIPTION OF THE DRAWINGS

FIG. 1 is a drawing showing an example of a conventional fluorescent lamp which is an external electrode type dielectric barrier discharge lamp, wherein FIG. 1 (a) is a side view and FIG. 1 (b) is a side cross section.

FIG. 2 is a block diagram showing an outline structure of a conventional lighting device for a discharge lamp and an operation of the lighting device including a current flow when a semiconductor switching element S2 is turned ON.

FIG. 3 is also a block diagram showing an outline structure of the conventional lighting device for a discharge lamp and the operation of the lighting device including a current flow when a semiconductor switching element S1 is turned ON.

FIG. 4 is a timing chart showing signal waveforms of each part in conventional lighting device for a discharge lamp when frequency is 20 kHz and a light control ratio is 100%.

FIG. 5 is a waveform chart of a lamp voltage and a lamp current when the frequency is 20 kHz and the light control ratio is 100% in a conventional example.

FIG. 6 is an enlarged view of the waveform at a portion B1 in FIG. 5.

FIG. 7 is a graph showing a measured luminance-frequency characteristics of the conventional external electrode type fluorescent lamp enclosed with rare gas of 120 torr or higher and with a constant input power.

FIG. 8 is a graph showing a measured luminance-frequency characteristics of the conventional external electrode type fluorescent lamp enclosed with rare gas of 120 torr or higher and with a constant input voltage.

FIG. 9 is a block diagram showing an embodiment of a lighting device for a discharge lamp according to the present invention.

FIG. 10 is a chart of a pulse waveform showing a relation between an output pulse of the drive signal generation circuit shown in FIG. 9 and a light control ratio.

FIG. 11 is a waveform chart of the lamp voltage and the lamp current observed by an oscilloscope in the lighting device for a discharge lamp shown in FIG. 9, when the drive frequency is 27 kHz and the light control ratio is 100%.

FIG. 12 is an enlarged view of the waveform at a portion A1 in FIG. 11.

FIG. 13 is a waveform chart of the lamp voltage and the lamp current observed by an oscilloscope in the lighting device for a discharge lamp shown in FIG. 9, when the drive frequency is 20 kHz and the light control ratio is 2%.

FIG. 14 is an enlarged view of the waveform at a portion A2 in FIG. 13.

FIG. 15 is a timing chart (a reference example) showing signal waveforms of an each part in the lighting device for a discharge lamp shown in FIG. 9 when the drive frequency is 25 kHz and the light control ratio is 2%.

FIG. 16 is a waveform chart (a reference example) showing the lamp voltage and the lamp current observed by an oscilloscope in the lighting device for a discharge lamp shown in FIG. 9 when the drive frequency is 27 kHz and the light control ratio is 2%.

FIG. 17 is an enlarged view of the waveform at a portion A3 in FIG. 16.

### DETAILED DESCRIPTION OF THE INVENTION

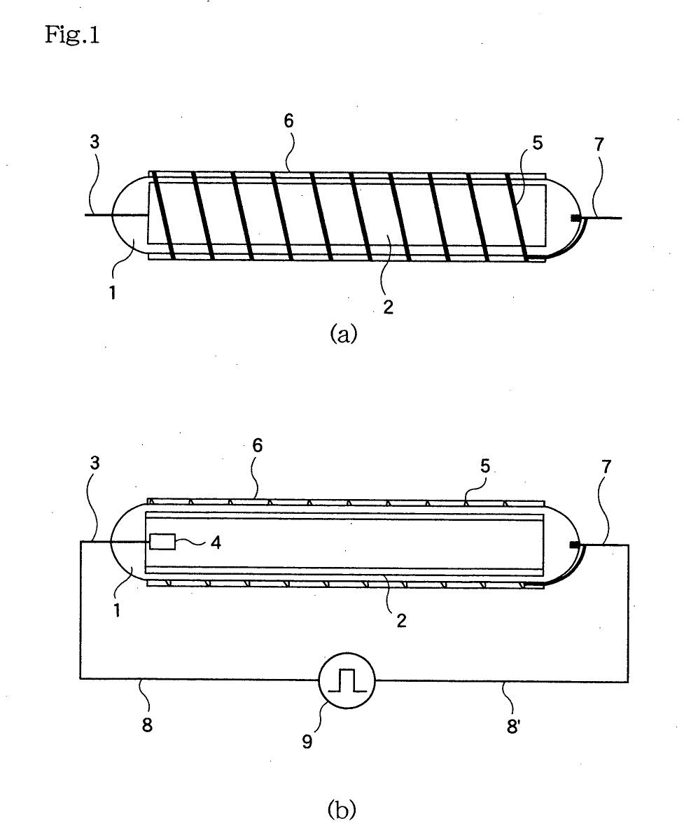

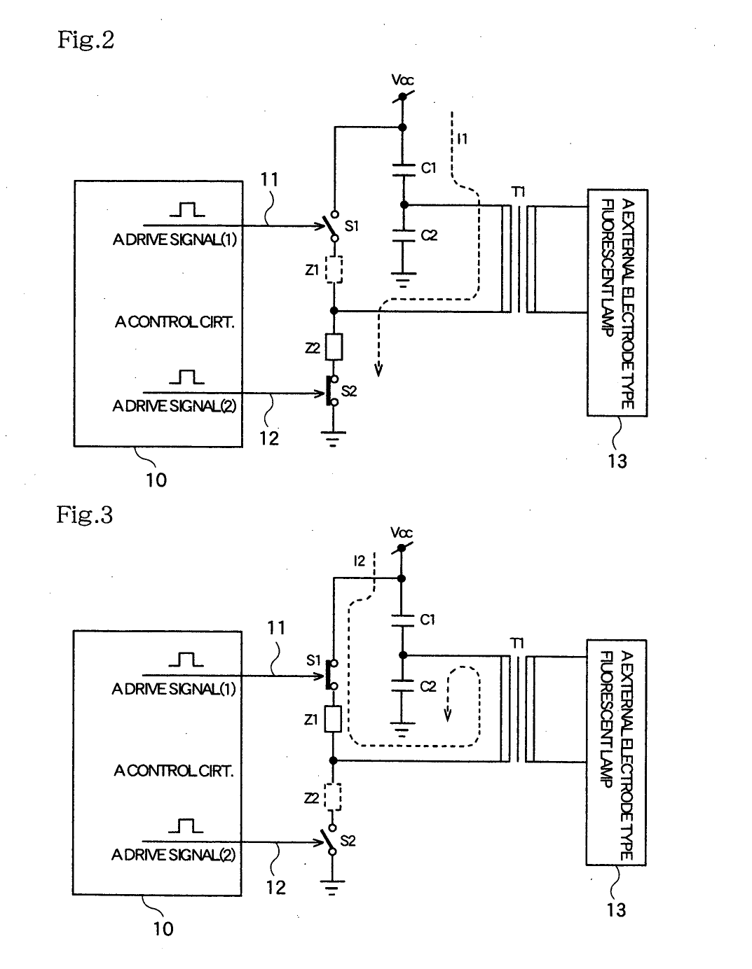

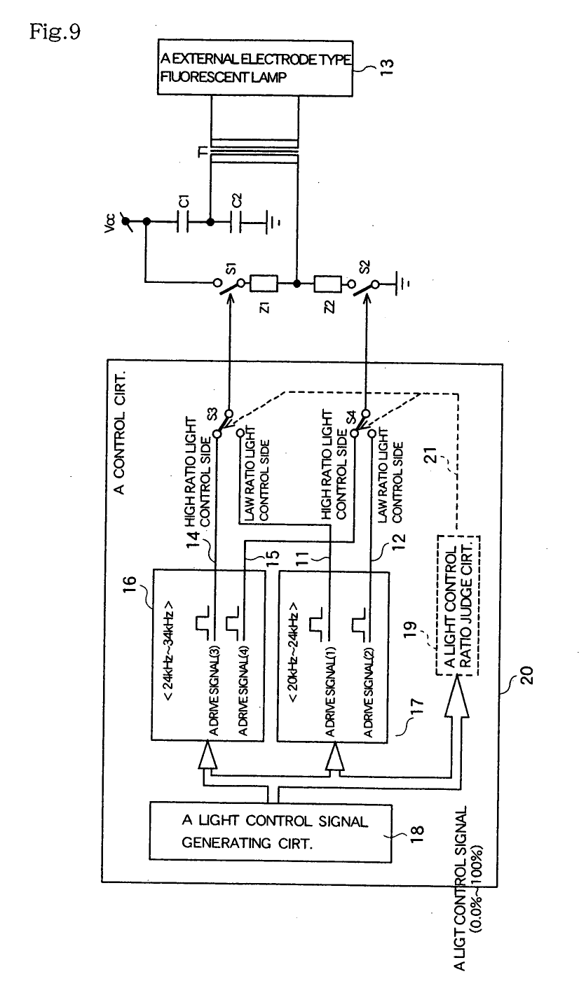

Hereinafter, embodiments of the present invention will be explained referring to the figures appended. FIG. 9 is a circuit diagram of a lighting device for a discharge lamp according to an embodiment of the present invention. The lighting device has partially the same configuration as the conventional discharge device shown in FIG. 2 or FIG. 3. That is, an external electrode type fluorescent lamp 13 having the same structure as the conventional discharge lamp shown in FIG. 1 is connected with the secondary coil of the transformer T1. However, pressure of rare gas in the glass tube 1 is equal to or higher than 120 torr.

One end of the primary coil of the transformer T1 is connected with the connecting point of a pair of capacitors C1, C2 connected in series. The pair of capacitors C1, C2 connected in series is connected between a power source potential Vcc and a ground potential GND. That is, one end of the primary coil of the transformer T1 is connected with the midpoint of the bias potential between the power source potential Vcc and the ground potential. The other end of the primary coil of the transformer T1 is connected with the connecting point of the pair of capacitors C1, C2 connected in series. Each of the circuit elements Z1, Z2 is composed of elements having resistance components such as coils, diodes, resistors etc. or combination their of.

The circuit elements Z1 and Z2 connected in series are connected between the power source potential Vcc and the ground GND potential through semiconductor switching elements S1, S2. A control circuit 20 is provided for controlling semiconductor switching elements S1 and S2.

The control circuit 20 is provided with a drive signal circuit 16 for high ratio light control, which outputs a pulse drive signal (3)14 and a pulse drive signal (4)15 each having a predetermined frequency in the range from 24 kHz to 34 kHz and a phase different from each other by 180°. The control circuit 20 is also provided with a drive signal circuit 17 for low ratio light control, which outputs pulse drive signal (1)11 and a pulse drive signal (2)12 each having a predetermined frequency in the range exceeding an audible signal range of from 20 kHz to 23 kHz and a phase different from each other by 180°. The control circuit 20 is further provided with a light control signal generating circuit 18 which supplies the light control signal as an output signal to the drive signal circuit 16 for the high ratio light control and the drive signal circuit 17 for low ratio light control. Here, the drive signals (1), (2), (3) and (4) generated are pulse width modulated signals to adjust the light control ratio. The light control signal is also supplied to a light control ratio judge circuit 19. The light control ratio judge circuit 19 judges light control ratio from the light control signal provided and outputs a signal select command 21 according to the result of judgments. The judgments is made in such manner that the input light control ratio is a high ratio if it is higher than a prescribed ratio, for example 25%, and it is a low ratio if it is lower than the prescribed ratio. The signal select command 21 is supplied to the drive signal select switches S3 and S4, and drives the drive signal select switches S3 and S4. The drive signal select switches S3, S4 selectively supply any one of the output signals of the drive signal circuit 16 or 17 to the semiconductor switching elements S1 and S2.

The output signals of the drive signal circuit 16 for the high ratio light control and of the drive signal circuit 17 for low ratio light control are modulated with respect to their pulse widths by the light control signal, which is the output signal of the light control signal generating circuit 18. Supplying the external electrode type fluorescent lamp 13 with the drive signal thus modulated, the light control ratio of the lamp 13 is varied from 0 to 100% continuously.

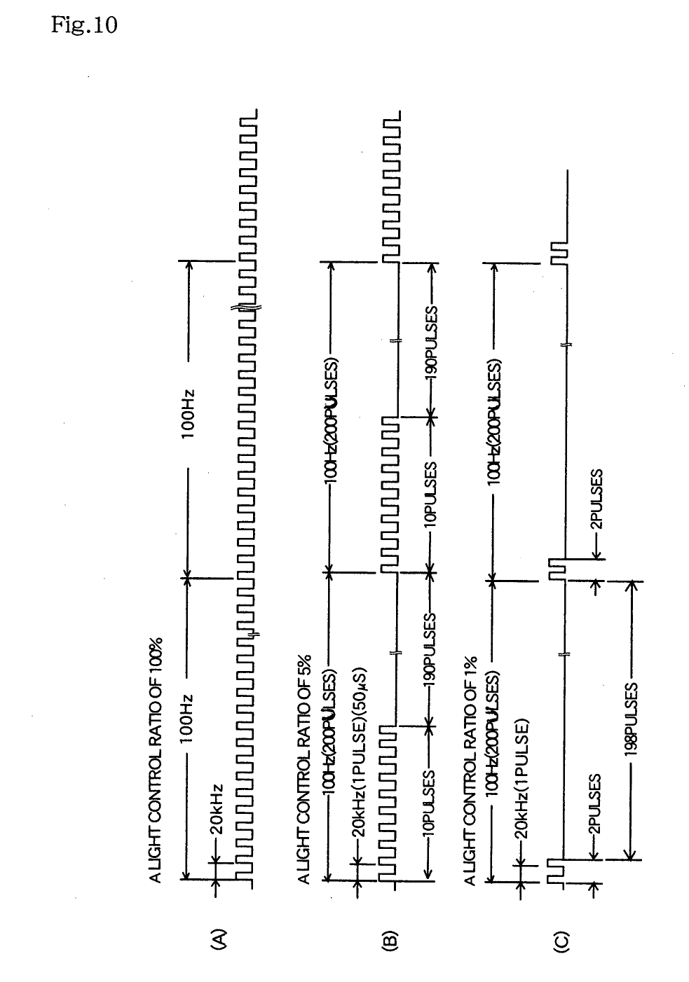

FIG. 10 is a pulse waveform chart showing a relation between the output pulses of the drive signal generating circuit 17 and the light control ratio. Since the same principle is applied to the drive signal generating circuit 16, the explanation is made only about the drive signal generating circuit 17 as a representative.

FIG. 10(A) is a waveform chart of drive signal 11 (or 12) when the light control ratio is 100%. The repetition period is 50 μs when the repetition frequency of the drive signal 11 is 20 kHz, for example. Here, if 0.01 second is supposed to be a unit time, which is equal to one period of time of a signal having a repetition frequency of 100 Hz, the number of output pulses from the drive signal generating circuit 11 per unit time is 200. That is, the drive signal 11 generates 200 pulses per unit time with a repetition frequency of 100 Hz while the light control ratio is 100%.

FIG. 10(B) is a waveform chart of drive signal 11 (or 12) when the light control ratio is 5%. The number of the output pulses from the drive signal generating circuit 17 for the low light control ratio is 10 per unit time.

FIG. 10(C) is a waveform chart of drive signal 11 (or 12) when light control ratio is 1%. The number of output pulses of the drive signal generating circuit 17 is 2 s per unit time.

The output signal of the light control signal generating circuit 18 is a binary signal of n digit, which indicates the light control ratio from 0 to 100 (%). The drive signal generating circuit 17 counts the number of the output pulse per unit time, which is designated by the output signal of the light control signal generating circuit 18 using a built-in microcomputer and outputs the result.

Next, an operation of the lighting device for the external electrode type fluorescent lamp 13 having the structure mentioned above is explained firstly in case of the high ratio light control and secondly in case of the low ratio light control.

Firstly, in the high ratio light control operation, the light control ratio at present is judged from the light control signal 18 using the light control ratio judge circuit 19 shown in FIG. 9. The drive signal select switch S3 and S4 are switched on the high ratio light control drive signal circuit 16 side, if the light control ratio is higher than 25%, for example. As a result, the semiconductor switching elements S1 and S2 are driven into ON/OFF state alternately by the drive signal (3)14 and the drive signal (4)15, the frequency of which are selected as one in the range from 24 kHz to 34 kHz.

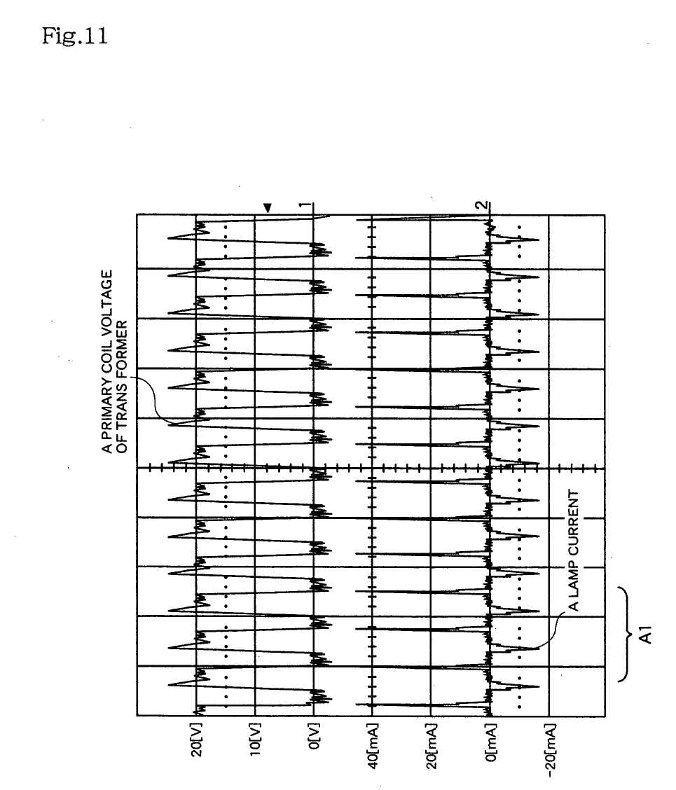

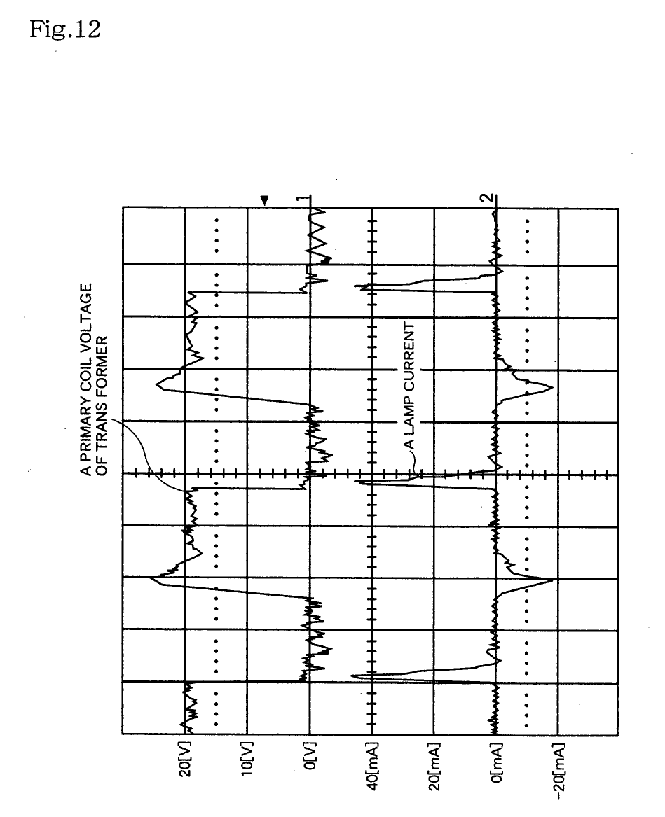

When the semiconductor switching elements S1, S2 are driven into ON/OFF state alternately, HF current flows in the primary coil of the transformer T1 in a similar operation as the conventional circuit shown in FIG. 2 and FIG. 3. A lamp current is thus generated in the secondary coil as shown in FIG. 11 and FIG. 12, with which the external electrode type fluorescent lamp 13 is lit.

That is, a positive lamp current is generated when the semiconductor switching element S1 is turned OFF by the drive signal (3)14 and the semiconductor switching element S2 is turned ON by the drive signal (4)15, similarly as shown in FIG. 2. In the next pulse timing, a negative lamp current is generated when the semiconductor switching element S1 is turned ON by the drive signal (3) 14 and the semiconductor switching element S2 is turned OFF by the drive signal (2)15, similarly as shown in FIG. 3. In this way, the voltage in the primary coil of the lamp drive transformer T1 repeats a change between a low level (L) and a high level (H) in a manner as L→H→L→H→L→H . . . during “ON” period of the drive signal (3) 14 and the drive signal (4)15. In this process, a positive and a negative lamp current are supplied to the xenon external electrode type fluorescent lamp 13 connected with the secondary coil of the transformer T1.

FIG. 11 and FIG. 12 show the actual waveform observed by an oscilloscope when the frequency of the drive signal (3) and (4) are 27 kHz and the light control ratio is 100% respectively. In one cycle period of the lamp current, there are periods during which the lamp current does not flow both in the positive and the negative direction, where the longer the period, the less flickering occurs.

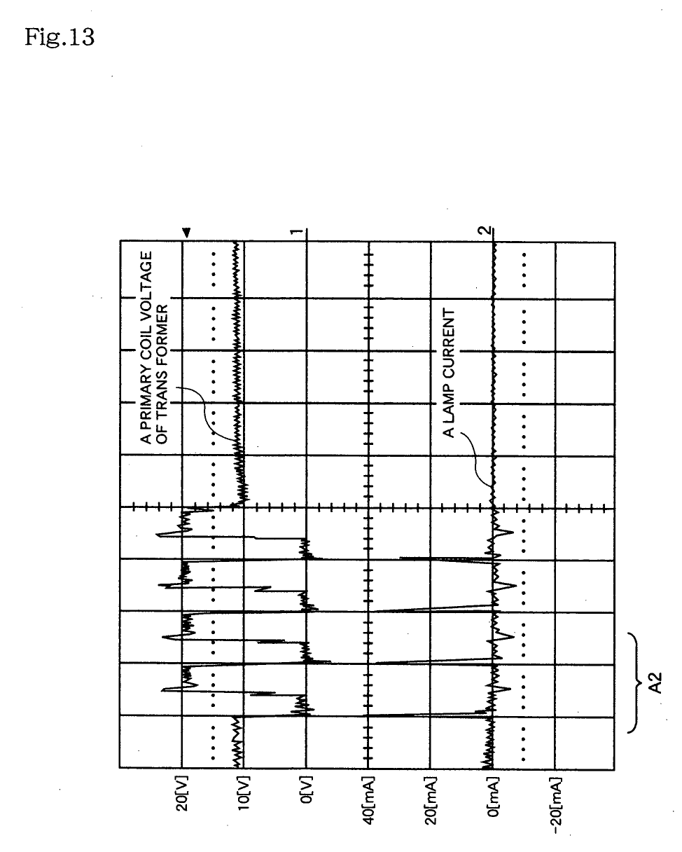

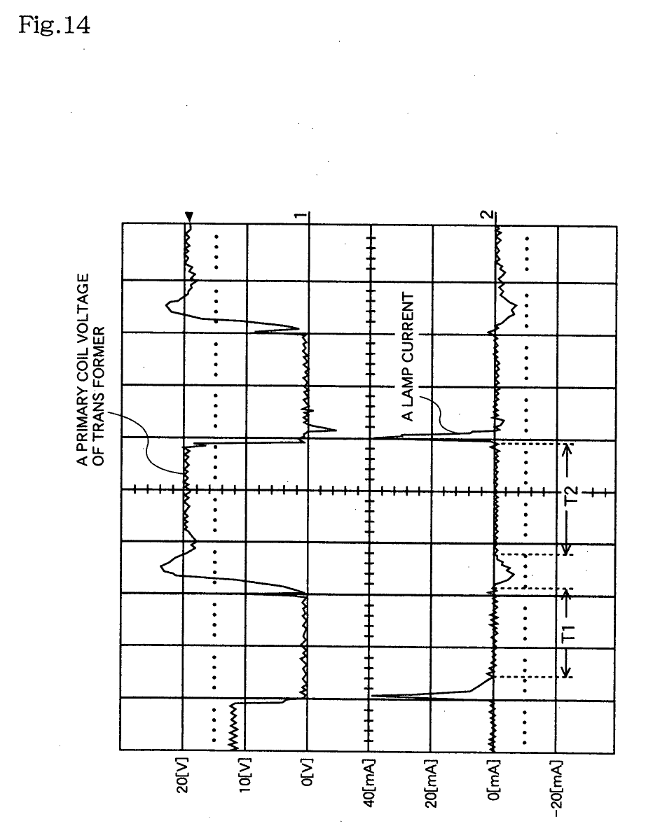

Next, in the low light control ratio lighting operation, the light control ratio is judged using the light control ratio judge circuit from the light control signal 18. The drive signal select switch S3 and S4 are switched on the low ratio light control drive signal circuit 17 side in the control circuit 20, if the light control ratio is lower than 25%. As a result, the low light control drive signal circuit 17 drives the semiconductor switching element S1 and S2 in ON/OFF state alternately using the drive signal (1)11 and the drive signal (2)12 each having a frequency selected in the range from 20 kHz to 24 kHz. When the semiconductor switching element S1 and S2 are driven in ON/OFF state alternately by drive signal (1)11 and the drive signal (2)12, HF current flows in the primary coil of the transformer T1 in a similar action as in the conventional circuit shown in FIG. 2 and FIG. 3. In this action, the lamp current is generated in the secondary coil as shown in FIG. 13 and FIG. 14. Thus, the external electrode type fluorescent lamp 13 is lit.

FIG. 13 and FIG. 14 are actual waveform chart observed by an oscilloscope when the frequency of the drive signal (1) and (2) are 20 kHz and the light control ratio is 2.0%, respectively. In one cycle of the lamp current, there are periods T1, T2 during which the lamp current does not flow both in positive and negative direction, where the longer the period, the less the flickering occurs.

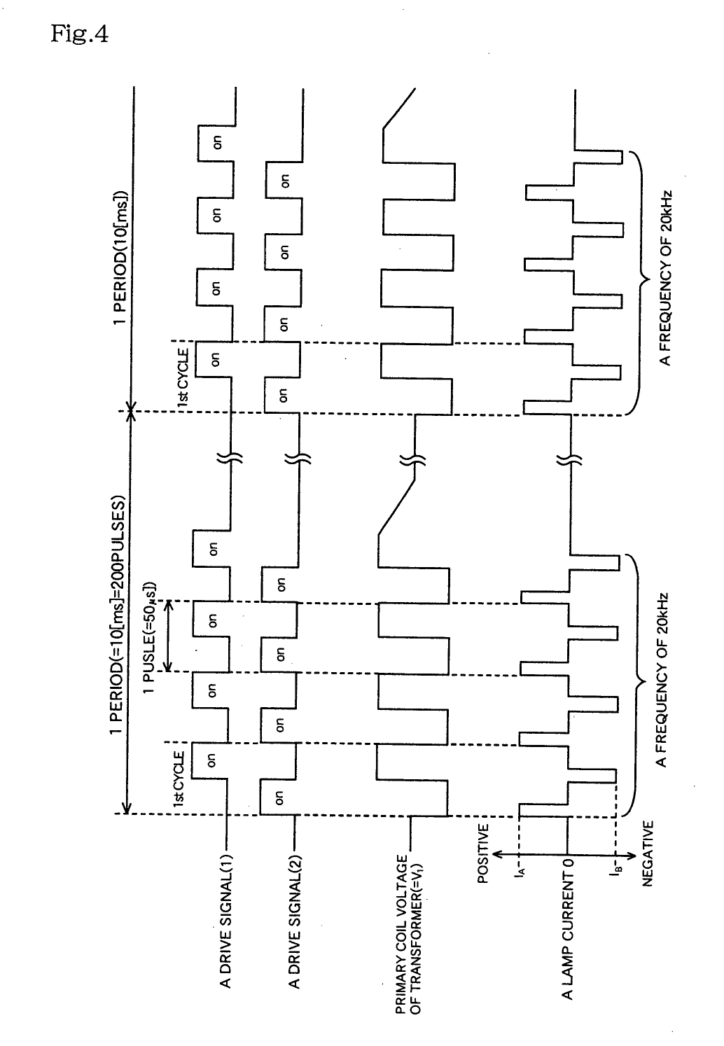

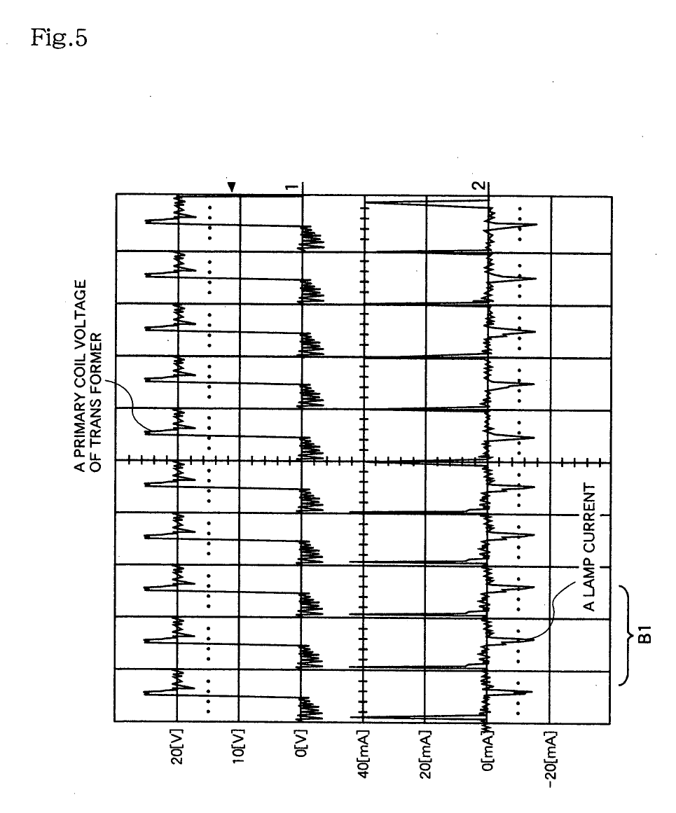

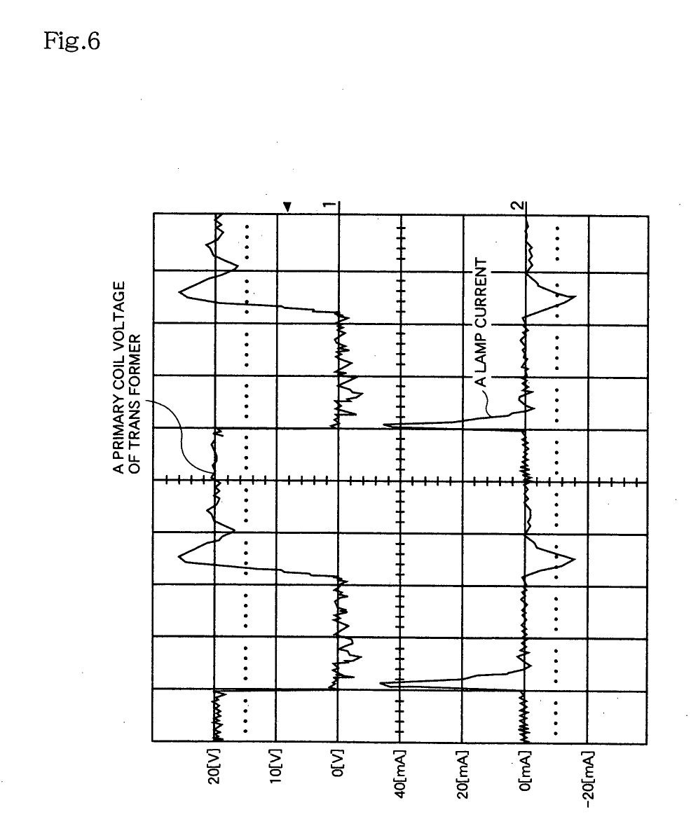

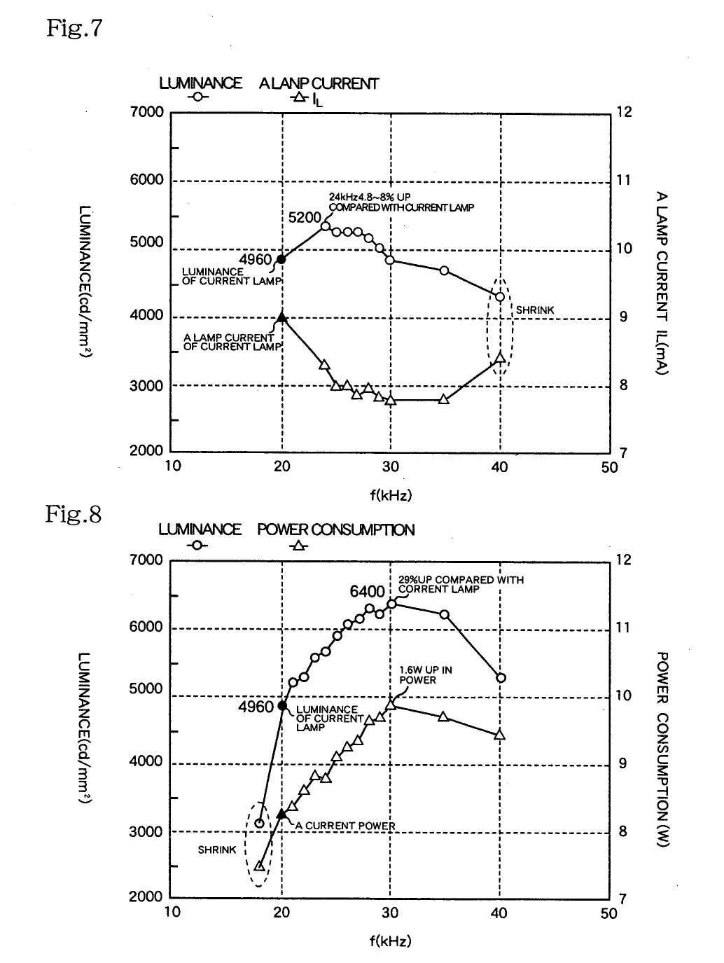

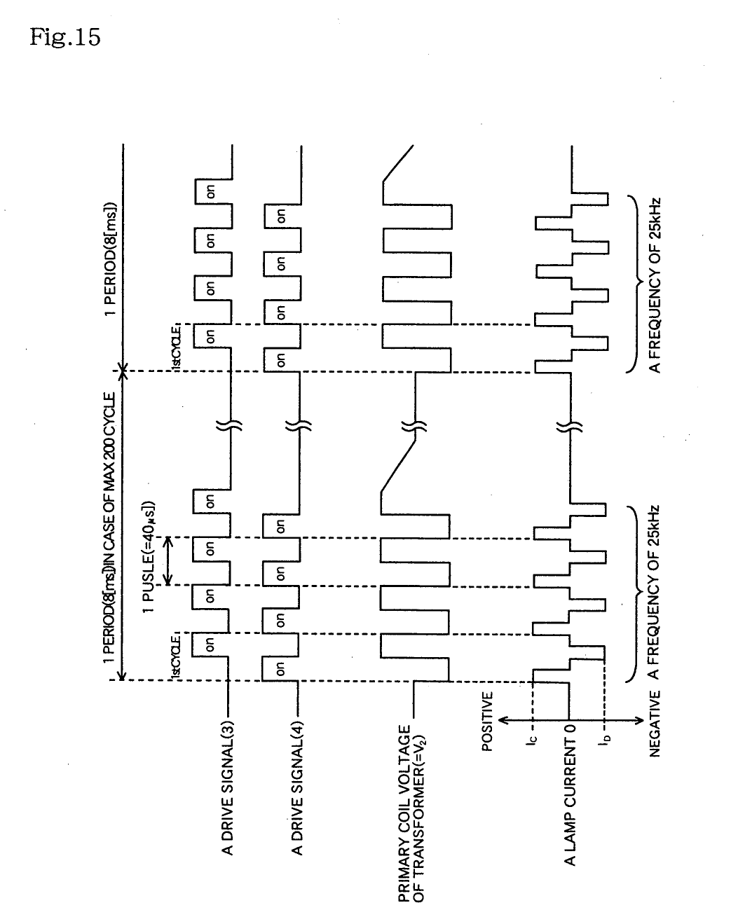

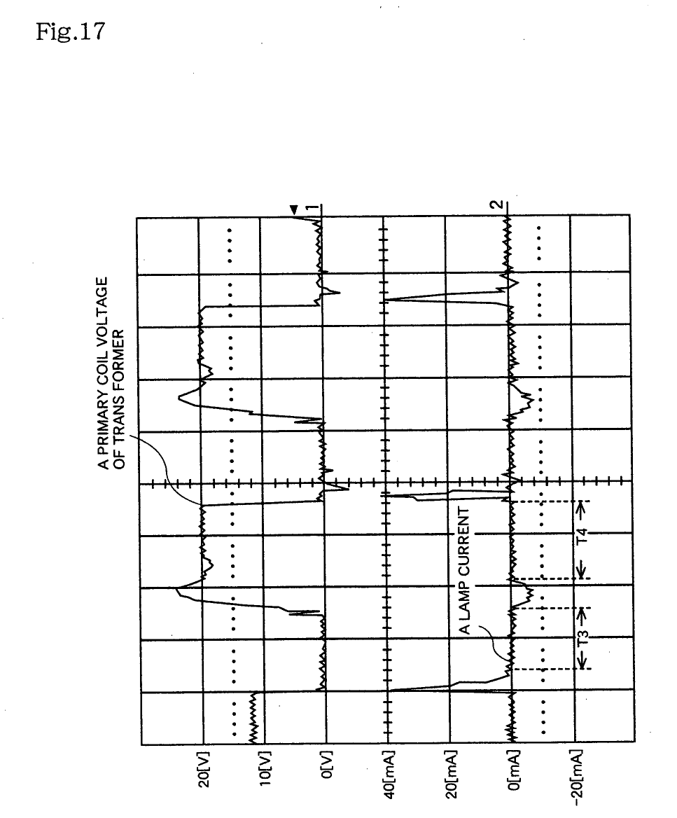

FIG. 15 is a timing chart (a reference example) showing signal waveforms at various parts in the lighting device for a discharge lamp shown in FIG. 9, where the drive signal frequency is 25 kHz and the light control ratio is 2%. In the present invention, the drive signal frequency of 25 kHz should be applied when the light control ratio is high and should not be applied actually when the light control ratio is as low as 2%. However, it is shown as a reference example The lighting pulse shown in the charts appears till the number of the pulses reaches 200 at maximum in the case the light control ratio is 100%. In the timing chart, four pulses were shown in the case when the light control ratio is 2% in order to compare with FIG. 4 which is the timing chart of the conventional circuit. As shown in the timing chart shown in FIG. 15, the lamp current IC and ID becomes less than IA and IB respectively (IC<IA, ID<IB, showing low lamp current, when the frequency is selected as 25 kHz and the lamp power is constant. Further, the timing chart shows that the period during which the current does not flow becomes shorter than that in the case of conventional circuit when frequency is 25 kHz, which means the flickering occurs. These relations are also shown in FIG. 14 and FIG. 17.

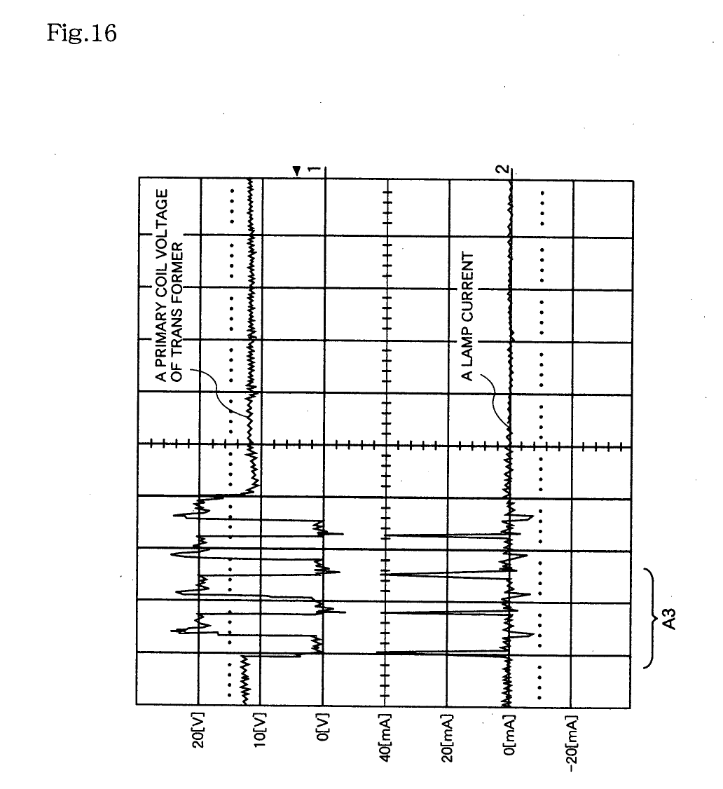

FIG. 16 and FIG. 17 are waveform chart of the real lamp drive voltage and current when the frequency is 27 kHz and the light control ratio is 2.0% observed by an oscilloscope. In the present invention, the drive signal frequency of 27 kHz should be applied when light control ratio is high and, therefore, the lighting at such low light control ratio is not used actually. However, the chart is shown as a reference example.

By comparing the waveform at low light control ratio and low frequency shown in FIG. 14 with the waveform of the comparison sample shown in FIG. 17, it can be seen from the real waveform that the period during which the lamp current does not flow becomes shorter, that is, T3<T1, T4<T2 when the switching frequency is high.

As mentioned above, in the lighting device for a discharge lamp according to the embodiment of the present invention, the drive signal frequency of the discharge lamp is selected at a frequency in the frequency band ranging from 24 kHz to 34 kHz, which does not make noise of audible range, in the lighting mode of the high ratio light control including at 100%. In the mode of the low ratio lighting, the semiconductor switching elements S1 and S2 are driven at a lower frequency in the frequency band ranging from 20 kHz to 24 kHz. As a result, stable and high luminance lighting is possible with no shrink of the positive column in the lamp at the high light control ratio. In the low ratio light control lighting, the lamp current frequency becomes low and stable lamp lighting without flickering is possible. Therefore, according to the above-mentioned lighting device for a discharge lamp, stable, high ruminant and flickering free lighting is possible in the entire light control range of the discharge lamp.

Here, although the HF power source circuit of a half bridge type is used in the above-mentioned embodiment, however, the type of the HF power source is not specially limited. For example, a power source circuit of full bridge type or of a push-pull type can be used.

1. A lighting device for a discharge lamp comprising:
an HF power source device for generating HF voltage with a prescribed frequency; and
an external electrode type dielectric barrier discharge lamp using rare gas as a discharge medium, which is supplied with the HF voltage from the HF power source device,
wherein the external electrode type florescent lamp having a gas pressure of equal to or higher than 120 torr and the frequency of the HF voltage is in the range from 24 kHz to 34 kHz.

2. A lighting device for a discharge lamp according to claim 1, wherein the HF power source device is further comprising:
a light control signal generating circuit;
a circuit for generating a drive signal with a first frequency selected from 24 kHz to 34 kHz range and a drive signal with a second frequency selected from 20 kHz to 24 kHz range, each of which is modulated in pulse width by the output signal of the light control signal generating circuit;
a light control ratio judge circuit to which the output of the light control signal generating circuit is supplied;
a drive signal selection switch which selectively provides the drive signal of the first frequency or the drive signal of the second frequency by the output signal of the light control ratio judge circuit;
a switching element driven by the drive signal of the first or the second frequency selected by the drive signal selection switch; and
a transformer having a primary coil connected with the switching element and a secondary coil connected with the external electrode type dielectric barrier discharge lamp,
wherein the drive signal selecting switch selects the drive signal of the first frequency when the light control ratio judged by the light control ratio judge circuit is equal to or higher than a prescribed value and selects the drive signal of the second frequency when the light control ratio is equal to or lower than a prescribed value, supplying the selected drive signal to the switching element.

3. A lighting device for a discharge lamp according to claim 2, wherein the circuit generating the drive signals further comprises:
a first drive signal generating circuit for generating the drive signal of the first frequency; and
a second drive signal generating circuit for generating the drive signal of the second frequency,
and wherein the first and second drive signal generating circuits generate the drive signals having substantially a same frequency and inverted phases.

4. A lighting device for a discharge lamp according to claim 3, wherein the switching elements are a first and a second semiconductor switching elements connected in series between a DC power source and a ground and the first and the second semiconductor switching elements are in alternating ON/OFF states controlled by the output pulse signals of the first and the second drive signal generating circuit.

5. A lighting device for a discharge lamp according to claim 4, wherein one end of the primary coil of the transformer is connected with the connecting point of a first and a second capacitors connected in series between the DC power source and the ground and the other end of the primary coil is connected with the connecting point of the first and the second semiconductor switching elements connected in series.

6. A lighting device for a discharge lamp according to claim 5, wherein the prescribed value of the light control ratio is about 25%.

7. A lighting device for a discharge lamp according to claim 2, wherein the rare gas enclosed in the external electrode dielectric barrier discharge lamp contains xenon, neon and argon, but does not contain mercury.

8. A lighting device for a discharge lamp according to claim 7, wherein the external electrode type fluorescent lamp comprises a glass tube inside which the rare gas is enclosed, a phosphor applied on the inner wall of the glass tube, an inner electrode sealed in one end of the glass tube through a lead-in wire, and an external electrode made of electricity conducting material provided on the outer wall of the glass tube along the tube axis.

9. A lighting device for a discharge lamp according to claim 8, wherein the external electrode is an electricity conducting wire wound spirally around the outer wall of the glass tube.

10. A lighting device for a discharge lamp comprising:
a light control signal generating circuit;
a circuit for generating a drive signal of a first frequency selected from a range from 24 kHz to 34 kHz and a drive signal selected from a range from 20 kHz to 24 kHz, which are modulated in pulse width by the output signal of the light control signal generating circuit;
a light control ratio judge circuit, which is provided with the output signal of the light control signal generating circuit;
a drive signal selection switch, which selects either one of the drive signal of the first frequency and the drive signal of the second frequency;
a switching element, which is driven by the drive signal of the first or the second frequency selected by the drive signal selection switch; and
a transformer having a primary coil, to which the switching element is connected and a secondary coil, to which an external electrode type dielectric barrier discharge lamp is connected,
wherein the drive signal selection switch selects the drive signal of the first frequency when the light control ratio judged by the light control ratio judge circuit is higher than or equal to the prescribed value, and selects the drive signal of the second frequency when the light control ratio judged by the light control ratio judge circuit is lower than or equal to the prescribed value, supplying the drive signal thus selected to the switching element.

11. A lighting device for a discharge lamp according to claim 10, wherein the circuit for generating the drive signal is provided with a first drive signal generating circuit for generating the drive signal of the first frequency and a second drive signal generating circuit for generating the drive signal of the second frequency, and wherein the first and second drive signal generating circuits generate the drive signals having substantially a same frequency and inverted phases.

12. A lighting device for a discharge lamp according to claim 11, wherein the switching elements are a first and a second semiconductor switching elements which are connected in series between the DC power source and the ground, and each of the semiconductor switching elements is controlled ON/OFF by the pulse signals of the first and the second drive signal generating circuits.

13. A lighting device for a discharge lamp according to claim 12, wherein one end of the primary coil of the transformer is connected with the connecting point of a first and a second capacitors which are connected in series between the DC power source and the ground, the other end of the primary coil is connected with the connecting point of the first and the second semiconductor switching elements connected in series.

14. A lighting device for a discharge lamp according to claim 13, wherein the prescribed value of the light control ratio is about 25%.

15. A lighting device for a discharge lamp according to claim 14, wherein the rare gas enclosed in the external electrode type dielectric barrier discharge fluorescent lamp contains xenon, neon, and argon, but does not contain mercury.

16. A lighting device for a discharge lamp according to claim 15, wherein the external electrode type dielectric barrier discharge lamp comprises a glass tube in which a rare gas is enclosed, a phosphor applied on the inner wall of the glass tube, an inner electrode sealed in one end of the glass tube through a lead-in wire, and an external electrode made of electricity conducting material provided on the outer wall of the glass tube along the tube axis.

17. A lighting device for a discharge lamp according to claim 16, wherein the external electrode is an electricity conducting wire wound spirally around the outer wall of the glass tube.

18. A lighting device for a discharge lamp comprising:
an HF power source device for generating HF pulse voltage;
an external electrode type dielectric barrier discharge lamp which is supplied with the HF pulse voltage from the HF power source device and is enclosed with rare gas of 120 torr or higher pressure as a discharge medium; and
a means for modulating the HF pulse voltage from the HF power source by a light control information used for luminance control of the discharge lamp,
wherein the HF power source device controls to decrease the drive frequency of the discharge lamp when the light control information indicates a low light control ratio range, in which flickering in the luminance of the discharge lamp is seen, and to increase the drive frequency of the discharge lamp when the light control information indicates a high light control ratio range, in which flickering is not seen.

19. A lighting device for a discharge lamp according to claim 18, wherein the low light control ratio range in which the flickering of the discharge lamp is seen is lower than 25%, the high light control ratio range in which the flickering is not seen is higher than 25%.

20. A lighting device for a discharge lamp according to claim 19, wherein the drive frequency of the discharge lamp is in the range from 24 kHz to 34 kHz when the light control ratio is higher than 25%, and the frequency is in the range from 20 kHz to 24 kHz when the light control ratio is lower than 25%.
